(19) United States
(12) Patent Application Publication
(10) Pub. No.: US 2024/0161057 A1
(43) Pub. Date: May 16, 2024

(54) SYSTEM FOR STOCKING AND MANAGING RENTAL APPARATUS

(71) Applicant: SHENZHEN PONY SYSTEMS TECH CO LTD, Shenzhen (CN)

(72) Inventor: Yongli Wang, Shenzhen (CN)

(21) Appl. No.: 18/419,699

(22) Filed: Jan. 23, 2024

(30) Foreign Application Priority Data
Aug. 28, 2023 (CN) 202311096336.8

(51) Int. Cl. G06Q 10/087; G06K 19/07; G06Q 30/0645

(52) U.S. Cl. CPC G06Q 10/087; G06K 19/0723; G06Q 30/0645

(57) ABSTRACT

The present invention provides a system for stocking and managing a rental apparatus, including: the rental apparatus: a usage-time counting unit being configured to cyclically execute a time counting event when a connected apparatus body is detected to be powered on, and stop the execution of the time counting event when the connected apparatus body is detected to be powered off, the time counting event being configured to calculate a usage-time variable of the apparatus body, and write the usage-time variable into a wireless tag; and a warehouse managing unit, including a wireless reader-writer arranged at an entrance and an exit of a warehouse.

### TECHNICAL FIELD

The present invention belongs to the technical field of LED display, and specifically relates to a system for stocking and managing a rental apparatus.

### BACKGROUND

In general, some large-scale stage performances and cultural activity sites rent a plurality of performance apparatuses (such as rental LED display screen, a lighting apparatus and so on) to build a stage. To meet the requirements of rapid installation, disassembly, and transport in a rental situation, an LED display screen may be designed with a customized die-casting aluminum box, for example. Generally, these rental apparatuses are billed for lease payment based on usage time, while the usage time of the rental apparatus is generally determined based on the time of in-and-out-of-storage. However, in most cases, the rental apparatus is also transported on a road for a general period of time after leaving a warehouse, which leads to the settled usage time of the rental apparatus to be longer than actual usage time, and results in inaccurate calculation of the usage time of the rental apparatus. In addition, in-and-out-of-storage management of an existing rental company on the rental apparatus is still stuck in a manual paper management stage, which has high labor costs and low management efficiency.

### SUMMARY

To overcome the defects in the prior art, the present invention provides a system for stocking and managing a rental apparatus, which can accurately count the usage time of the rental apparatus and automatically manage the in-and-out-of-storage of the rental apparatus.

A system for stocking and managing a rental apparatus includes:
the rental apparatus: including a plurality of apparatus bodies, a usage-time counting unit connected to each of the apparatus bodies, and a wireless tag provided within the apparatus body;
the usage-time counting unit being configured to cyclically execute a time counting event when a connected apparatus body is detected to be powered on, and stop execution of the time counting event when the connected apparatus body is detected to be powered off, the time counting event being configured to calculate a usage-time variable of the apparatus body, and write the usage-time variable into a wireless tag;
a warehouse managing unit, including a wireless reader-writer arranged at an entrance and an exit of a warehouse, and a managing unit, the wireless reader-writer being configured to read the data of the wireless tag on the apparatus body when the apparatus body passes through the entrance and the exit of the warehouse, and send the data to the managing unit, the managing unit being configured to count the in-and-out-of-storage of the apparatus body based on the data.

Further, the time counting event is specifically configured to:
turn on a first timer for timing;
accrue an updated interval variable once on the usage-time variable, when the timing of the first timer is equal to the updated interval variable; and
reset the first timer.

Further, the time counting event is specifically used to:
turning on the second timer for timing;
accrue the timing of the second timer on the usage-time time variable when the connected apparatus body is detected to be powered off;
reset the second timer.

Further, the rental apparatus is further configured to write the status of the apparatus body into the wireless tag.

The data of the wireless tag read by the wireless reader-writer includes the status of the apparatus body and the usage-time variable.

Further, the apparatus body is further provided thereon with an electronic ink screen. The electronic ink screen is configured to read and display the status of the apparatus and the usage-time variable in the wireless tag when the connected apparatus body is detected to be powered off.

Further, the managing unit is specifically configured to:
record the status and the usage-time variable of each of the apparatus bodies uploaded by the wireless reader-writer and update the number of the rental apparatus out of storage, when the apparatus body is out of storage;
record the status and the usage-time variable of each of the apparatus bodies uploaded by the wireless reader-writer and update the number of the rental apparatus out of storage, when the apparatus body is put in storage;
calculate a difference between the usage-time variable at the time of in-storage of each of the apparatus bodies and the usage-time variable at the time of out-of-storage of each of the apparatus bodies to obtain the current usage time of the apparatus body.

Further, the managing unit is further configured to:
generate a maintenance or replacement prompt when the usage-time variable of the apparatus body is detected to reach a lifespan threshold.

Further, the rental apparatus includes an LED display screen or a lighting apparatus.

Further, when the rental apparatus is the LED display screen and the apparatus body is a display-screen body, the rental apparatus further includes a brightness detecting unit connected to each of display-screen bodies. The brightness detecting unit is configured to:
set a test pixel value and a one-to-one corresponding test gray-scale value;
set all pixel points in the display-screen body as the same test pixel value;
photograph the LED display screen to obtain a display-screen image;
perform image processing on the display-screen image to obtain a gray-scale value for each of the pixel points in the display-screen image, and average all the gray-scale values to obtain an average gray-scale value.

When the average gray-scale value is equal to the test gray-scale value, the brightness of the display-screen body is detected not to pass the test.

When the average gray-scale value is not equal to the test gray-scale value, the brightness of the display-screen body is detected not to pass the test.

Further, the plurality of test pixel values are disclosed, and each of the test pixel values corresponds to a different hue.

As can be seen from the above technical solutions, the system for stocking and managing the rental apparatus provided by the present invention can accurately count the usage time of the rental apparatus, and automatically manage the in-and-out-of-storage of the rental apparatus at the same time.

### BRIEF DESCRIPTION OF THE DRAWINGS

To more clearly describe the implementation of the present invention or the technical solution in the prior art, the accompanying drawings to be used in the description of the embodiments or the prior art will be briefly described below. In all accompanying drawings, similar elements or parts are generally identified by similar reference signs. In the accompanying drawings, each of the elements or parts is not necessarily drawn based on actual scale.

FIG. 1 is a block diagram of a module of a system for stocking and managing a rental apparatus provided by an embodiment.

### DETAILED DESCRIPTION OF EMBODIMENTS

An embodiment of the technical solution of the present invention will be described in detail below in conjunction with the accompanying drawings. The following embodiments are only used to describe the technical solutions of the present invention more clearly, hence are only used as examples, and cannot be used to limit the protection scope of the present invention. It should be noted that unless otherwise specified, the technical or scientific terms used in the present invention should have general meanings understood by a person skilled in the art to which the present invention belongs.

It should be understood that, when used in this specification and the appended claims, the terms “including” and “comprising” are indicative of the presence of described features, integrals, steps, operations, elements, and/or assemblies, but do not preclude the presence or addition of one or more other features, integrals, steps, operations, elements, assemblies, and/or sets thereof.

It should also be understood that the terms used herein in the specification of the present invention are used solely for the objective of describing specific embodiments and are not intended to limit the present invention. As used in the specification and the appended claims of the present invention, the singular forms “a”, “one”, and “the” are intended to include the plural form unless the context clearly indicates otherwise.

As used in this specification and the appended claims, the term “if” may be interpreted contextually as “when”, “once” or “in response to determining” or “in response to detecting”. Similarly, the phrases “if it is determined” or “if [the described condition or event] is detected” may be interpreted contextually to mean “once it is determined”, “in response to determining”, “once [the described condition or event] is detected” or “in response to detecting [the described condition or event]”.

### Embodiment

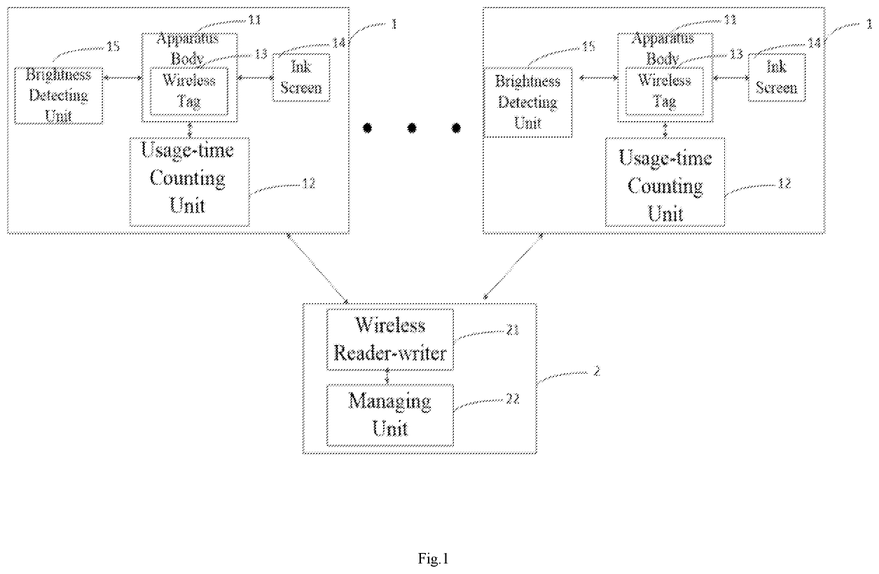

See FIG. 1, a system for stocking and managing a rental apparatus includes:
the rental apparatus 1: including a plurality of apparatus bodies 11, a usage-time counting unit 12 connected to each of the apparatus bodies 11, and a wireless tag 13 provided within the apparatus body 11;
the usage-time counting unit 12 being configured to cyclically execute a time counting event when a connected apparatus body 11 is detected to be powered on, and stop execution of the time counting event when the connected apparatus body 11 is detected to be powered off, the time counting event being configured to calculate a usage-time variable of the apparatus body 11, and write the usage-time variable into a wireless tag 13;
a warehouse managing unit 2, including a wireless reader-writer 21 arranged at an entrance and an exit of a warehouse, and a managing unit 22, the wireless reader-writer 21 being configured to read the data of the wireless tag 13 on the apparatus body 11 when the apparatus body 11 passes through the entrance and the exit of the warehouse, and send the data to the managing unit 22, the managing unit 22 being configured to count the in-and-out-of-storage of the apparatus body 11 based on the data.

In the embodiment, in general, a scene of a stage performance or a cultural activity generally requires the leasing of a screen or a light. The apparatus body 11 may be a display-screen body or a light body. The entire screen is assembled from the plurality of display-screen bodies. The entire light also consists of the plurality of light bodies. Each of the apparatus bodies 11 in the system is connected to one usage-time counting unit 12. The apparatus body 11 and the usage-time counting unit 12 are in a one-to-one correspondence.

In the embodiment, the usage-time counting unit 12 is mainly configured to count the accrued usage time of the apparatus body 11 connected thereto. Because the apparatus body 11 cannot be used normally until the apparatus body 11 is powered on, the usage-time counting unit 12 obtains the usage time of the apparatus body 11 by counting the power-on time of the apparatus body 11. For example, when the apparatus body 11 is detected to be powered on, the apparatus body 11 starts to count the power-on time. When the apparatus body 11 is detected to be powered off, the apparatus body 11 stops to count the power-on time, thereby obtaining the usage time of the apparatus body 11. The apparatus body 11 and the usage-time counting unit 12 may communicate wirelessly via wireless technology. The apparatus body 11 is provided therein with the wireless tag 13 for storing the usage-time variable of the apparatus body 11 counted in the usage-time counting unit 12. The usage-time counting unit 12, when calculating the usage-time variable of the apparatus body 11, writes the usage-time variable into the wireless tag 13 by wired means. The wireless tag 13 may be an NFC tag or other wireless communication tags.

In the embodiment, the warehouse managing unit 2 also realizes an automatic management function when the apparatus body 11 enters or leaves the warehouse. The wireless reader-writer 21 is provided at the entrance and the exit of the warehouse. The wireless reader-writer 21 may be an NFC reader or other wireless communication readers that match the wireless tag 13. When the apparatus body 11 exits the warehouse through the entrance and the exit of the warehouse, the wireless reader-writer 21 senses the wireless tag 13 on the apparatus body 11 and reads the data in the wireless tag 13, such as reading the usage-time variable in the wireless tag 13. When the apparatus body 11 is put in storage through the entrance and the exit of the warehouse, the wireless reader-writer 21 senses the wireless tag 13 on the apparatus body 11 and reads the data in the wireless tag 13, such as reading a usage-time variable in the wireless tag 13. This allows the managing unit 22 to know the usage-time variable of the apparatus body 11 at the time of the in-and-out-of-storage, so as to count the in-and-out-of-storage of the apparatus body 11.

In the embodiment, most of the apparatus bodies 11 also need to be provided with a plurality of parameters, such as parameters of the display-screen body including a resolution ratio, a screen ratio, a refresh rate, HDR, and so on. The system provides a parameter quick configuration function by setting a parameter adjusting unit connected thereto for each of the apparatus bodies 11. When the rental apparatus 1 needs to adjust the parameters of all the apparatus bodies 11 at the same time, the rental apparatus 1 may first set one apparatus body 11 as a reference apparatus. A user may first manually adjust the parameters of the reference apparatus based on current time, weather, and other factors, so that the reference apparatus can present better results. When the reference apparatus completes the manual adjustment, a parameter adjusting instruction is generated based on an adjusted parameter value, and sent to the other apparatus bodies 11, so that the other apparatus bodies 11 can synchronize the parameters of the reference apparatus. The other apparatus bodies 11, when receiving the parameter adjusting instruction, begins to synchronize the parameters and parses the parameter adjusting instruction to obtain all the parameter values of the reference apparatus, and configures the apparatus body 11 based on all the parameter values, which can facilitate the user's uniform adjustment of the parameters of the rental apparatus 1.

The system for stocking and managing the rental apparatus can accurately count the usage time of the rental apparatus and automatically manage the in-and-out-of-storage of the rental apparatus at the same time.

Further, in some embodiments, the time counting event is specifically configured to:
turn on a first timer for timing;
accrue an updated interval variable once on the usage-time variable, when the timing of the first timer is equal to the updated interval variable; and
reset the first timer.

In the embodiment, the usage-time variable and the updated interval variable may be set as global variables so that the values of the usage-time variable and the updates interval variable are not reset at each time when the time counting event stops executing. When the time counting event is called, the first timer is first turned on to time. When the timing of the first timer is equal to the updated interval variable, the updated interval variable is accrued once on the usage time variable. For example, it is assumed that the updated interval variable is set to 10 seconds. Then, when the first timer times for 10 seconds, the timer is reset, and 10 seconds are accrued to the usage-time variable, so that the usage-time variable can cyclically accrue the timer's timing to accurately count the power-on time of the apparatus body 11.

In the embodiment, the usage-time counting unit 12, when counting the powered on time, may accrue the usage-time variable based on the set updated interval variable. The updated interval variable, which reflects the frequency of updates, can be set in advance or modified as needed during use. If the updated interval variable is set shorter, it results in a faster update frequency of the usage-time variable, more frequent data writing, and higher power consumption. However, the usage-time variable can more accurately reflect the usage time of the apparatus body 11. If the updated interval variable is set longer, it results in a slower update frequency of the usage-time variable, and lower power consumption. However, there is a certain delay error in the usage-time variable.

Further, in some embodiments, the time counting event is specifically configured to:
turn on a second timer for timing;
accrue the timing of the second timer on the usage-time time variable when the connected apparatus body 11 is detected to be powered off; and
reset the second timer.

In the embodiment, the time counting event may also count the usage time of the apparatus body 11 at a single time, and then accrue the counted usage-time into the usage-time variable when the apparatus body 11 is powered off. For example, it is supposed that the display-screen body A is powered on at 3:00, at which time the time counting event is called. When the second timer starts to time, the display-screen body A is powered off at 3:30, at which time the second timer stops timing, and 30 minutes are added to the usage-time variable of the display-screen body A to obtain the latest accrued usage time of the display-screen body A. The second timer is reset.

Further, in some embodiments, the rental apparatus 1 is also configured to write the status of the apparatus body 11 into the wireless tag 13.

The data of the wireless tag 13 read by the wireless reader-writer 21 includes the status of the apparatus body 11 and the usage-time variable.

In the embodiment, the wireless tag 13 also stores the status of the apparatus body 11. The status includes power-on and power-off, so that the user may also obtain the status of the apparatus by reading the wireless tag 13.

Further, in some embodiments, the apparatus body 11 is further provided thereon with an electronic ink screen 14. The electronic ink screen 14 is configured to read and display the status of the apparatus and the usage-time variable in the wireless tag 13 when the connected apparatus body 11 is detected to be powered off.

In the embodiment, the apparatus body 11 is also provided thereon with the electronic ink screen 14. The electronic ink screen 14 may be active so that the electronic ink screen 14 can be used normally even when the apparatus body 11 is powered off. The electronic ink screen 14 is mainly configured to display the usage-time variable and the apparatus status in the wireless tag 13 so that, regardless of whether the apparatus body 11 is powered on or powered off, the user may directly view the accrued usage time and the status of the apparatus body 11 through the electronic ink screen 14, which is convenient and fast.

Further, in some embodiments, the managing unit 22 is specifically configured to:
record the status and the usage-time variable of each of the apparatus bodies 11 uploaded by the wireless reader-writer 21 and update the number of the rental apparatus out of storage, when the apparatus body 11 is out of storage;
record the status and the usage-time variable of each of the apparatus bodies 11 uploaded by the wireless reader-writer 21 and update the number of the rental apparatus out of storage, when the apparatus body 11 is put in storage;
calculate a difference between the usage-time variable at the time of in-storage of each of the apparatus bodies 11 and the usage-time variable at the time of out-of-storage of each of the apparatus bodies 11 to obtain the current usage time of the apparatus body 11.

In the embodiment, the managing unit 22 reads the status of the apparatus and the usage-time variable in the wireless tag 13 and updates the number of the rental apparatus out of storage when the apparatus body 11 is out of storage and put in storage, respectively, e.g., the number of the rental apparatus out of storage is increased by 10 when there are 10 apparatus bodies 11 out of storage. The number of the rental apparatus out of storage is decreased by 10 when there are 10 apparatus bodies 11 in storage. The managing unit 22 calculates, when the apparatus body 11 is put into storage, a difference between the usage-time variable at the time of the in-storage of the apparatus body 11 and the usage-time variable at the time of the out-of-storage of the apparatus body 11 to obtain the current usage time of the apparatus body 11. For example, when the apparatus body is out of storage, the usage-time variable read is 120 hours. When the apparatus body is put in storage, the usage-time variable read is 130 hours. The two usage-time variables are subtracted to obtain the current usage time of 10 hours of the apparatus body.

Further, in some embodiments, the managing unit 22 is also configured to:
generate a maintenance or replacement prompt when the usage-time variable of the apparatus body 11 is detected to reach a lifespan threshold.

In the embodiment, the managing unit 22 may also monitor the usage-time variable of the apparatus body 11 in real time. When the usage-time variable reaches the lifespan threshold, it indicates that the use of the apparatus body 11 reaches an upper limit and needs to be repaired or replaced. At this time, the user is prompted to carry out repair or replacement in a timely manner.

Further, in some embodiments, when the rental apparatus 1 is an LED display screen and the apparatus body 11 is a display-screen body, the rental apparatus 1 further includes a brightness detecting unit 15 connected to each of the display-screen bodies. The brightness detecting unit 15 is configured to:
set a test pixel value and a one-to-one corresponding test gray-scale value;
set all pixel points in the display-screen body as the same test pixel value;
photograph the LED display screen to obtain a display-screen image;
perform image processing on the display-screen image to obtain a gray-scale value for each of the pixel points in the display-screen image, and average all the gray-scale values to obtain an average gray-scale value.

When the average gray-scale value is equal to the test gray-scale value, the brightness of the display-screen body is detected to pass a test;

When the average gray-scale value is not equal to the test gray-scale value, the brightness of the display-screen body is detected not to pass the test.

In this embodiment, the brightness detecting unit 15 is mainly configured to detect the brightness of the display-screen body. The brightness detection includes detecting whether the brightness of the display-screen body as a whole is consistent or not, detecting whether there are pixel points of missing brightness in the display-screen body, and so on. The brightness detecting unit 15 first sets the test pixel value and the one-to-one corresponding test gray-scale value. The plurality of test pixel values are disclosed. Each of the test pixel values corresponds to a different hue, respectively. For example, a test pixel value A and a corresponding test gray-scale value A are set for a red hue. The test gray-scale value A is the gray-scale value corresponding to the pixel point A in a picture obtained by taking the picture of the display-screen body 1 after the pixel point A in the display-screen body 1 is set as the test pixel value A. The test pixel value and the test gray-scale value that are in one-to-one correspondence may also be set for yellow, blue, green, and other hues. It can be detected whether the brightness of the display-screen body in displaying different colors is qualified.

When the brightness detecting unit 15 starts the test, the brightness detecting unit 15 sets all the pixel points in the display-screen body as the same test pixel value, for example, sets all the pixel points in the display-screen body to display red, yellow, or blue, and so on. After setting all the pixel points in the display-screen body to display the same color, the brightness detecting unit 15 photographs the display-screen body to obtain the display-screen image. Next, image processing is performed on the display-screen image to obtain the gray-scale value of each of the pixel points in the display-screen image. The image processing includes filtering, enhancement, recognition, and so on. Then, the brightness detecting unit 15 averages all the gray-scale values to obtain the average gray-scale value. When all the pixel points in the display-screen body can be displayed normally, the average gray-scale value is equal to the gray-scale value corresponding to the color, i.e., the test pixel value corresponding to the test gray-scale value. When one or more pixel points in the display-screen body cannot be displayed normally or lacks brightness, it results in the gray-scale value of the pixel point in the display-screen image being slightly larger or slightly smaller than the test gray-scale value. The average gray-scale value obtained at this time is also not equal to the test gray-scale value. The brightness detecting unit may set an error value when determining. When a difference between the average gray-scale value and the test gray-scale value is less than the error value, the average gray-scale value is considered to be equal to the test gray-scale value. Therefore, the brightness detecting unit 15, when determining that the average gray-scale value is equal to the test gray-scale value, considers that all the pixel points in the display-screen body can be displayed normally. The brightness of the display-screen body is detected to pass the test. When it is determined that the average gray-scale value is not equal to the test gray-scale value, it is considered that there is a part of the pixel points in the display-screen body that cannot be displayed normally, and the brightness of the display-screen body is detected not to pass the test. In addition, the user can also be reminded to confirm a brightness test result. When it is determined that the brightness is detected not to pass the test, the display-screen body is repaired or replaced in a timely manner.

Finally, it should be noted that the foregoing embodiments are intended for describing instead of limiting the technical solutions of the present invention. Although the present invention is described in detail with reference to the foregoing embodiments, a person skilled in the art should understand that modifications may be made to the technical solutions described in the foregoing embodiments or equivalent replacements may be made to some or all technical features thereof, without departing from the scope of the technical solutions. All these modifications or replacements shall fall within the scope of the claims and specification of the present invention.

What is claimed is:

1. A system for stocking and managing a rental apparatus, comprising:
the rental apparatus: comprising a plurality of apparatus bodies, a usage-time counting unit connected to each of the apparatus bodies, and a wireless tag provided within the apparatus body;
the usage-time counting unit being configured to cyclically execute a time counting event when a connected apparatus body is detected to be powered on, and stop execution of the time counting event when the connected apparatus body is detected to be powered off, the time counting event being configured to calculate a usage-time variable of the apparatus body, and write the usage-time variable into a wireless tag;
a warehouse managing unit, including a wireless reader-writer arranged at an entrance and an exit of a warehouse, and a managing unit, the wireless reader-writer being configured to read data of the wireless tag on the apparatus body when the apparatus body passes through the entrance and the exit of the warehouse, and send the data to the managing unit, the managing unit being configured to count in-and-out-of-storage of the apparatus body based on the data.

2. The system for stocking and managing the rental apparatus according to claim 1, wherein the time counting event is specifically configured to:
turn on a first timer for timing;
accrue an updated interval variable once on the usage-time variable, when the timing of the first timer is equal to the updated interval variable; and
reset the first timer.

3. The system for stocking and managing the rental apparatus according to claim 1, wherein the time counting event is specifically configured to:
turn on a second timer for timing;
accrue timing of the second timer on the usage-time time variable when the connected apparatus body is detected to be powered off; and
reset the second timer.

4. The system for stocking and managing the rental apparatus according to claim 1,
wherein the rental apparatus is further configured to write a status of the apparatus body into the wireless tag;
the data of the wireless tag read by the wireless reader-writer includes a status of the apparatus body and the usage-time variable.

5. The system for stocking and managing the rental apparatus according to claim 4,
wherein the apparatus body is further provided thereon with an electronic ink screen; the electronic ink screen is configured to read and display the status of the apparatus and the usage-time variable in the wireless tag when the connected apparatus body is detected to be powered off.

6. The system for stocking and managing the rental apparatus according to claim 4, wherein the managing unit is specifically configured to:
record the status and the usage-time variable of each of the apparatus bodies uploaded by the wireless reader-writer and update the number of the rental apparatus out of storage, when the apparatus body is out of storage;
record the status and the usage-time variable of each of the apparatus bodies uploaded by the wireless reader-writer and update the number of the rental apparatus out of storage, when the apparatus body is put in storage;
calculate a difference between the usage-time variable at the time of in-storage of each of the apparatus bodies and the usage-time variable at the time of out-of-storage of each of the apparatus bodies to obtain current usage time of the apparatus body.

7. The system for stocking and managing the rental apparatus according to claim 4, wherein the managing unit is further configured to:
generate a maintenance or replacement prompt when the usage-time variable of the apparatus body is detected to reach a lifespan threshold.

8. The system for stocking and managing the rental apparatus according to claim 1,
wherein the rental apparatus comprises an LED display screen or a lighting apparatus.

9. The system for stocking and managing the rental apparatus according to claim 8, wherein when the rental apparatus is the LED display screen and the apparatus body is a display-screen body, the rental apparatus further comprises a brightness detecting unit connected to each of the display-screen bodies; and the brightness detecting unit is configured to:
set a test pixel value and a one-to-one corresponding test gray-scale value;
set all pixel points in the display-screen body as the same the test pixel value;
photograph the LED display screen to obtain a display-screen image;
perform image processing on the display-screen image to obtain a gray-scale value for each of the pixel points in the display-screen image, and average all the gray-scale values to obtain an average gray-scale value;
when the average gray-scale value is equal to the test gray-scale value, brightness of the display-screen body is detected to pass a test;
When the average gray-scale value is not equal to the test gray-scale value, the brightness of the display-screen body is detected not to pass the test.

10. The system for stocking and managing the rental apparatus according to claim 9,
wherein the plurality of test pixel values are disclosed, and each of the test pixel values corresponds to a different hue.
